(19) United States
(12) Patent Application Publication
(10) Pub. No.: US 2008/0252862 A1
(43) Pub. Date: Oct. 16, 2008

(54) Light Reflector, Method for Manufacturing the Same and Projector

(75) Inventors: Takahiro Okura, Ome-shi (JP); Masakazu Takei, Ome-shi (JP); Nobumitsu Hamana, Kawaguchi-shi (JP); Hisao Aoki, Kawaguchi-shi (JP); Fujio Owada, Kawaguchi-shi (JP); Naoki Amai, Kawaguchi-shi (JP)

Correspondence Address: HOGAN & HARTSON L.L.P., 1999 AVENUE OF THE STARS, SUITE 1400, LOS ANGELES, CA, 90067, US

(73) Assignees: KYOCERA CHEMICAL CORPORATION, Kawaguchi-shi, Saitama (JP); KYOCERA OPTEC CO., LTD., Ome-shi, Tokyo (JP)

(21) Appl. No.: 11/718,383

(22) PCT Filed: Nov. 2, 2005
(86) PCT No.: PCT/JP2005/020231

§ 371 Date: Feb. 7, 2008

(30) Foreign Application Priority Data
Nov. 2, 2004 (JP) 2004-319773
Dec. 13, 2004 (JP) 2004-359525
Apr. 20, 2005 (JP) 2005-121928
Apr. 20, 2005 (JP) 2005-121929

(51) Int. Cl. G03B 21/28; F21V 7/00; B29D 11/00

(52) U.S. Cl. 353/98; 362/341; 264/1.9

(57) ABSTRACT

A light reflector which can be manufactured easily by using a plastic base material that is light weight and low cost and has high reflectivity, and a method for manufacturing the same. The light reflector comprises a plastic base material 50 of which thermal deformation temperature is 130° C. or higher, and a reflecting film 52 containing silver and formed on the surface of the base material, wherein said plastic base material 50 is a molded article of thermosetting resin and the reflecting film has a smooth surface with PV (peak-to-valley) roughness of 0.5 μm or less without sharp protrusions and reflectivity of the reflecting film is 96% or more.

### TECHNICAL FIELD

The present invention relates to a light reflector which comprises a base material made of plastics and has high reflectivity, and more particularly to a light reflector preferably used for image forming in projectors or projection television sets or for illumination, a method for manufacturing the same and a projector.

### RELATED ART

Video projectors are classified into front projection type projector and rear projection type projector. The front projection type projector comprises a reflective screen disposed along a wall of a room and a projector unit including micro devices, projection lens, and the like disposed at the center of the room, so that modulated light is projected from the projection lens onto the screen and an image is displayed on the screen. Viewer watches the modulated light reflected on the screen. The rear projection type projector comprises a projector unit including micro devices and projection lens disposed within a housing, and a transmission screen disposed in front of the housing. Viewer watches the modulated light which has transmitted through the screen outside of the housing.

Recently researches have been conducted on the rear projection type projector having large screens such as 70 to 100 inches in diagonal size. A rear projection type projector having such a large screen requires a distance of two meters or more between the projection lens and the screen, with the housing becoming significantly large. To keep the housing from becoming larger, a mirror is disposed between the projection lens and the screen, thereby decreasing the depth of the housing.

Patent Documents 1 and 2 describe projectors aimed at smaller housing and larger view angle. The projector projects an image on a screen by using four reflectors to reflect light flux from an image forming element.

In case an image is projected by using a plurality of light reflectors in this way, a clear image of high quality cannot be obtained when the light reflector has low reflectivity, regardless of whether the reflector has convex, concave or plane surface.

In case a surface reflector mirror made of glass is used for the mirror disposed between the projection lens and the screen, the mirror has a surface area of 1.5 m by 1.1 m or more in the case of a rear projection type projector having large screen. The mirror would weigh 20 kg or more when formed with a thickness of 5 mm or more since glass is brittle and can easily break, thus resulting in entire apparatus weighing 100 kg or more.

To address this problem, Patent Document 3 proposes it to form the mirror disposed between the projection lens and the screen from plastics having a low specific gravity, about 60% that of glass. The mirror described in Patent Document 3 is constituted from a transparent plastic sheet of which one side is coated with a reflective metal such as silver or aluminum formed by vapor deposition.

However, as the screen becomes larger, the mirror also becomes larger and requires higher strength accordingly. However, a plastic base material formed by molding of an ordinary thermosetting resin cannot be strong enough even when the thickness is increased, and can easily break or crack.

It is well known that a plastic base material having high strength can be made from a resin composition containing reinforcing fibers such as glass fiber. However, a base material formed from a resin composition containing much reinforcing fibers has a surface of lower smoothness due to the reinforcing fibers. As a result, when the base material surface is coated with a reflective metal such as silver or aluminum by vapor deposition so as to form a reflecting film, there is a problem of low reflectivity of the reflecting film.

In the meantime, there is a demand for smaller depth of the rear projection type projector. In the rear projection type projector of the prior art, as shown in FIG. 15, an image produced by an optical engine 22 is reflected on a rear mirror 21 disposed in a housing and is projected onto a screen 23. With this vertical projection system, projecting distance L1 becomes 900 mm or more with projection angle of 80°, and therefore depth L2 of the projector becomes 500 mm or more.

In a rear projection type projector having reduced depth which has recently been proposed, an image produced by an optical engine 22 is projected obliquely by means of an aspherical mirror 24, and the image is reflected on a rear mirror 25 and is displayed on the screen 23. This constitution makes it possible to achieve an extremely large projection angle of 160° with the projecting distance L1 of 200 mm, thus enabling it to decrease the depth L2 of the projector to 200 mm or less. Pluralities of plane mirrors and aspherical mirrors may also be used whereon the image is reflected successively, depending on the constitution of the projector.

However, since the image is reflected successively on the pluralities of reflectors in the form of aspherical mirrors 24 and the rear mirrors 25, the image displayed on the screen 23 becomes dark unless the reflectors have high reflectivity. As a result, there is a demand for a reflector which is light in mass and has reflectivity of 96% or higher.

Patent Document 4 describes a reflector of high reflectivity which has a reflective layer of silver having reflectivity of 98% or higher in the visible light region. However, the reflector having reflectivity of 98% or higher described in Patent Document 4 is constituted from a glass base material. Use of glass base material results in such problems that it is difficult to reduce the mass and the cost is high since the surface must be polished with high accuracy.

In the case of a light reflector made by coating a base material, particularly a plastic base material, with a reflecting film containing silver, adhesion strength between the base material and the reflecting film is weak along the periphery of the reflecting film. As a result, there has been such a problem that water infiltrates between the base material and the reflecting film in the periphery, leading to gradual corrosion of the reflecting film from the periphery thereof and eventually causing the reflecting film to peel off the base material.
Patent Document 1: Japanese Unexamined Patent Publication (Kokai) No. 2002-40326
Patent Document 2: Japanese Unexamined Patent Publication (Kokai) No. 2003-177320
Patent Document 3: Japanese Unexamined Patent Publication (Kokai) No. H7-230072
Patent Document 4: Japanese Unexamined Patent Publication (Kokai) No. 2003-114313

### DISCLOSURE OF THE INVENTION

A main object of the present invention is to provide a light reflector which can be easily manufactured by using a plastic base material of light mass and low cost and has high reflectivity, and a method for manufacturing the same.

Another object of the present invention is to provide a light reflector having high strength and high reflectivity by using a plastic base material.

Further another object of the present invention is to provide a light reflector capable of suppressing the corrosion of the reflecting film from occurring due to water infiltrating between the base material and the reflecting film.

Another object of the present invention is to provide a projector capable of displaying a clear image of high quality by using a light reflector of light mass and low cost.

Through researches to achieve the objects described above, the inventors of the present invention successfully achieved a reflectivity of 96% or higher on the surface of a reflecting film of a light reflector constituted from a plastic base material coated with the reflecting film containing silver.

The light reflector of the present invention comprises the plastic base material of which thermal deformation temperature is 130° C. or higher and the reflecting film containing silver formed on the surface of the base material, and the reflecting film has a smooth surface of which P-V (peak-to-valley) roughness is 0.5 μm or less without sharp protrusions and reflectivity of the reflecting film is 96% or higher. A molded article of thermosetting resin may be used as the plastic base material.

The light reflector of the present invention preferably comprises the plastic base material including a reinforced plastic layer which contains 8 to 20% by mass of reinforcing fibers and a glossy plastic layer which contains 5% by mass or less reinforcing fibers and is formed on the reinforced plastic layer, and the reflecting film which contains silver and is formed to cover the glossy plastic layer of the plastic base material.

The plastic base material preferably has a protrusion provided along the periphery so as to surround the central portion which serves as a reflector to project the image.

A method for manufacturing the light reflector according to the present invention comprises the process of filling a mold with a thermosetting resin composition comprising 7 to 19% by mass of an unsaturated polyester resin, 6 to 19% by mass of a thermoplastic resin, 70 to 84% by mass of an inorganic filler, 5% by mass or less reinforcing fibers and 0.1 to 3% by mass of a curing agent, and heating the thermosetting resin composition at a temperature in a range from 135 to 180° C. so as to cure the thermosetting resin composition and mold the plastic base material, and the process of forming the reflecting film containing silver on the plastic base material.

A method for manufacturing another light reflector according to the present invention comprises the process of forming a reinforced plastic layer containing 8 to 20% by mass or less reinforcing fibers and a glossy plastic layer containing 5% by mass or less reinforcing fibers one on another so as to obtain the plastic base material, and the process of forming the reflecting film containing silver on the glossy plastic layer of the plastic base material.

A method for manufacturing another light reflector according to the present invention comprises molding of the thermosetting resin composition to obtain the plastic base material and coating the plastic base material with the reflecting film, wherein such a mold is used that has a recess in the border between a portion thereof corresponding to the peripheral portion of the plastic base material and a portion thereof corresponding to the central portion, so as to form a protrusion in the peripheral portion of the plastic base material to surround the central portion of the surface of the reflecting film.

A method for manufacturing another light reflector according to the present invention, in which the adhesion enhancing film, the reflecting film containing silver and a reflection improving film are formed one on another in this order on the plastic base material, comprises holding the plastic base material in a chamber, supplying gas for generating plasma into the chamber, generating a high frequency electric field in the space within the chamber, heating and evaporating evaporation materials which form the films in the chamber, and controlling the amount of a gas to be supplied wherein the amount of gas supplied into the chamber is controlled to be smaller in the latter period than in the early period of forming the films on the base material, so that the adhesion enhancing film, the reflecting film containing silver and the reflection improving film are formed by a thin film forming method which keeps the base material at a temperature not higher than 60° C. during the film forming process.

The projector of the present invention is provided with the light reflector described above. Specifically, the projector of the present invention projects an image onto a screen via at least three light reflectors which, referred to as first, second and third light reflectors along the light passing direction, are constituted such that at least the first and second light reflectors are made by forming the reflecting films containing silver on the plastic base material and the reflecting film has reflectivity of 96% or higher.

PV value and surface condition of the reflecting film can be measured with a non-contact three-dimensional profile measuring instrument (such as “NH-3SP” manufactured by Mitaka Kohki Co., Ltd.). In the present invention, the term “reflecting film containing silver” contains, in addition to a silver film comprising a single crystal of pure silver, reflecting films containing silver and other component to such an extent that does not affect the reflectivity of the reflecting film, as well.

The light reflector of the present invention is constituted by forming the reflecting film containing silver on the surface of the plastic base material which has thermal deformation temperature of 130° C. or higher. Therefore, the light reflector can be manufactured with light mass at a low cost, even when it has such a large size as 130 mm by 150 mm. In addition, since the reflecting film has a smooth surface having PV value of 0.5 μm or less without sharp protrusions and reflectivity of the reflecting film not lower than 96%, it is suited for use as aspherical mirror or plane mirror used in a thin rear projection type projector, particularly in a thin rear projection type projector having large screen. The plastic base material, when formed from a thermosetting resin, has high heat resistance.

The light reflector of the present invention, of which base material has the reinforced plastic layer, has high strength as well as high reflectivity since the base material surface whereon the reflecting film is formed has the glossy plastic layer which includes a smaller amount of reinforcing fibers.

In the light reflector of the present invention which has the protrusion formed along the peripheral portion of the reflecting film surface, water infiltrating between the base material and the reflecting film in the periphery is prevented from proceeding to the central portion by the protrusion formed along the peripheral portion of the reflecting film serving as a kind of dam, thus achieving an effect of suppressing the corrosion of the reflecting film in the central portion which serves as the reflecting surface.

According to the method of manufacturing the light reflector of the present invention, the light reflector having reflectivity of 96% or higher can be manufactured easily without the need of post processing such as polishing. When the plastic base material is made by molding a thermosetting resin composition comprising 7 to 19% by mass of an unsaturated polyester resin, 6 to 19% by mass of a thermoplastic resin, 70 to 84% by mass of an inorganic filler, 5% by mass or less reinforcing fibers and 0.1 to 3% by mass of a curing agent, surface of the plastic base material can be made smooth with PV value not larger than 0.5 μm without sharp protrusions. Accordingly the reflecting film, which substantially directly represents the surface condition of the plastic base material, also has a smooth surface of PV value not larger than 0.5 μm without sharp protrusions and reflectivity of the reflecting film can be made 96% or higher.

In case the plastic base material is formed by using a mold having a recess on the border between a portion thereof corresponding to the peripheral portion of the plastic base material and a portion thereof corresponding to the central portion, the protrusion can be formed in the peripheral portion of the reflecting film surface at the same time as the plastic base material is molded, and therefore the light reflector having high reflection characteristics can be manufactured easily at a low cost without increasing the number of processes.

Since the projector of the present invention uses the light reflector constituted from the plastic base material having the reflecting film containing silver formed on the surface thereof, the projector can be manufactured with light mass at a low cost. Moreover, since at least the first and second light reflectors located near an image forming member (for example, an image forming element) have reflectivity of 96% or higher, clear image of high quality can be produced.

Thus the light reflector of the present invention is suited for use as aspheric mirror or plane mirror used in a thin rear projection type projector, particularly in a thin rear projection type projector having large screen.

### BRIEF DESCRIPTION OF THE DRAWINGS

FIG. 1 is a sectional view showing a light reflector according to first embodiment of the present invention.

FIG. 2 schematically shows an example of a thin film forming apparatus used in manufacturing the light reflector of the present invention.

FIG. 3 is a diagram explanatory of processes of forming thin films.

FIG. 4 is a perspective view showing an application of the light reflector of the present invention.

FIG. 5 is a sectional view showing a light reflector according to second embodiment of the present invention.

FIG. 6 is schematic front view showing a light reflector for projection according to third embodiment of the present invention.

FIG. 7 is an enlarged view of the portion A in FIG. 6.

FIG. 8 is a schematic sectional view of a mold for molding the plastic base material of the present invention.

FIG. 9 is an enlarged view of the portion B in FIG. 8.

FIG. 10 schematically shows a projector according to fourth embodiment of the present invention.

FIG. 11 shows the result of three-dimensional profile measurement of the surface of a reflecting film obtained in Example 1.

FIG. 12 is an SEM photograph showing the surface condition of the reflecting film obtained in Example 1.

FIG. 13 is an SEM photograph showing a section of a light reflector having the reflecting film obtained in Example 1 formed thereon.

FIG. 14 shows the result of three-dimensional profile measurement of the surface condition of a reflecting film obtained in Comparative Example 1.

FIG. 15 is an explanatory diagram showing the operating principle of rear projection type projector.

FIG. 16 is an explanatory diagram showing the operating principle of thin rear projection type projector.

### DESCRIPTION OF REFERENCE NUMERALS

1 Boat
3 Heating power source
4 Matching device
5 High frequency power source
6 DC voltage source
9 Evaporation material
11 Chamber
20 Evaporation source
50 Plastic base material
51 Adhesion enhancing film
52 Reflecting film
53 First transparent dielectric layer
54 Second transparent dielectric layer

### DESCRIPTION OF THE PREFERRED EMBODIMENTS

### First Embodiment

The light reflector of the present invention is constituted by coating a plastic base material, of which thermal deformation temperature is 130° C. or higher, with a reflecting film containing silver.

A molded article of thermosetting resin may be used for the plastic base material in consideration of the thermal deformation temperature thereof. There is no restriction on the molded article of thermosetting resin as long as the thermal deformation temperature is 130° C. or higher. For example, various thermosetting resins may be used such as unsaturated polyester resin, epoxy resin, phenol resin and polycarbonate. It is particularly preferable to use unsaturated polyester resin.

In case unsaturated polyester resin is used, the thermosetting resin composition is preferably composed of 7 to 19% by mass of an unsaturated polyester resin, 6 to 19% by mass of thermosetting resin, 70 to 84% by mass of an inorganic filler, 5% by mass or less reinforcing fibers and 0.1 to 3% by mass of a curing agent, which is molded into a predetermined shape.

The unsaturated polyester resin is a liquid resin prepared by mixing an unsaturated polyester (prepolymer), which is obtained by polycondensing an acid component of an α,β-unsaturated dibasic acid or an anhydride thereof with a polyhydric alcohol, with a polymerizable monomer, and contains 65 to 75% by mass of an unsaturated polyester and 35 to 25% by mass of a polymerizable monomer.

Examples of the α,β-unsaturated dibasic acid or anhydride thereof used in the unsaturated polyester resin include one or more kinds of acid such as maleic acid, fumaric acid, itaconic acid, citraconic acid, or anhydrides thereof. Meleic acid or an anhydride thereof, or fumaric acid is used particularly preferably. Examples of the polyhydric alcohol include ethylene glycol, diethylene glycol, propylene glycol, dipropylene glycol and neopentyl glycol, and these polyhydric alcohols can be used alone or in combination.

Furthermore, the α,β-unsaturated dibasic acid or anhydride thereof and the polyhydric alcohol may be polycondensed with a saturated dibasic acid or an anhydride thereof to be added, if necessary. Examples of the saturated dibasic acid or anhydride thereof include phthalic acid or an anhydride thereof, isophthalic acid, terephthalic acid, tetrahydrophthalic acid, tetrahydrophthalic anhydride, adipic acid and sebacic acid, and these saturated dibasic acids may be used alone or in combination.

In addition to the above polyhydric alcohols, one or more of 1,3-propanediol, 1,3-butanediol, 1,4-butanediol, 1,6-hexanediol, 1,4-cyclohexanedimethanol and hydrogenated bisphenol A can be used in combination with the above polyhydric alcohols, if necessary.

Examples of the polymerizable monomer used in the unsaturated polyester resin include styrene, vinyltoluene, divinyltoluene, p-methylstyrene, methyl methacrylate, diallyl phthalate and diallyl isophthalate, and these polymerizable monomers may be used alone or in combination. A predetermined amount of the polymerizable monomer is mixed with the unsaturated polyester and the resulting mixture is mixed with the unsaturated polyester resin, and also a portion of the polymerizable monomer can be added upon preparation of the unsaturated polyester. The content of the unsaturated polyester in the resin composition is from 7 to 19% by mass, and preferably from 8 to 13% by mass.

Examples of the thermoplastic resin to be mixed to the resin composition include styrene-based copolymer, polyethylene, polyvinyl chloride, polyvinyl acetate, methyl polymethacrylate, methyl polymethacrylate-based copolymer, modified ABS resin, polycaprolactone and modified polyurethane. An acrylic resin (containing a copolymer) such as poly(methyl methacrylate) or poly(methyl methacrylate)-based copolymer, and a vinyl acetate-based resin (including a copolymer) such as polyvinyl acetate or styrene-vinyl acetate copolymer are particularly preferable in view of dispersibility, low shrinkage and rigidity. The content of the thermoplastic resin in the resin composition is from 6 to 19% by mass, and preferably from 8 to 12% by mass.

For the inorganic filler included in the resin composition, known inorganic fillers can be used such as calcium carbonate, mica, talc, graphite, carbon black, asbestos, and aluminum hydroxide. The inorganic filler preferably has mean particle size in a range from 0.1 to 60 μm, with crushed particle shape. Content of the inorganic filler in the resin composition is from 70 to 84% by mass.

The reinforcing fibers included in the resin composition increase the strength of the molded article. The reinforcing fibers may be, for example, glass fiber, carbon fiber, graphite fiber, aramid fiber, silicon carbide fiber, alumina fiber, boron fiber, steel fiber, amorphous fiber and organic fiber, which may be used individually or in a combination of two or more thereof.

The reinforcing fiber is preferably 1 to 3 mm in length and 5 to 100 μm in diameter. Content of the reinforcing fibers in the resin composition is preferably in a range from 0 to 5% by mass. In case the fibers are longer or the content thereof exceeds 5% by mass, PV value will exceeds 0.5 μm and it becomes difficult to obtain a smooth surface without sharp protrusions, as will be described later.

Examples of the curing agent for initiating the curing reaction of the unsaturated polyester resin include organic peroxides such as t-butylperoxy benzoate, t-butylperoxy-2-ethylhexanoate, t-butylperoxy isopropylcarbonate and 1,1-bis(t-butylperoxy)-3,3,5-trimethlcyclohexane. The content of the curing agent in the resin composition is from 0.1 to 3% by mass.

The thermosetting resin composition may also include a mold release agent so that the molded article can be easily released from the mold. For the releasing agent, aliphatic metal salts may be used such as zinc stearate, magnesium stearate, calcium stearate and aluminum stearate. Content of the mold release agent in the resin composition may be roughly from 0.1 to 3% by mass.

The thermosetting resin composition may also include a coloring agent such as pigment and/or a thickening agent such as magnesium oxide or calcium oxide as required.

The plastic base material of the present invention is made by placing the thermosetting resin composition in a mold and heating to a temperature from 135 to 180° C. so as to cure the thermosetting resin composition. The plastic base material may be molded by a method employed for the ordinary thermosetting resin such as injection molding, transfer molding or compression molding.

Shrinkage factor of the thermosetting resin composition during the molding process is preferably from 0.05 to −0.10%, in order to ensure smoothness of surface and dimensional stability of the molded article. Shrinkage factor of molding is the ratio of difference in the dimension between the molded article at the normal temperature and the mold at the normal temperature to the mold dimension, and is given as (mold dimension−molded article dimension)/mold dimension.

The mold is required to be smooth on the surface corresponding to the surface of the molded article whereon the reflecting film is to be formed, and specifically to meet the requirement of JIS B 0601-2001 that the surface roughness is 0.5 μm or less, and preferably 0.4 μm or less.

The plastic base material which has been molded has smooth surface with PV value not larger than 0.5 μm without sharp protrusions. Therefore, the reflecting film can be formed directly on the surface of the molded article which has been released from the mold, without the need of post processing such as providing a smoothing layer (such as undercoat layer) on the surface or polishing the surface. At the same time, the surface of the reflecting film which is heavily influenced by the surface of the plastic base material can be made smooth with PV value not larger than 0.5 μm without sharp protrusions.

Then the reflecting film containing silver is formed on the surface of the plastic base material thus obtained. This may be done either by directly forming the reflecting film containing silver by a method to be described later, or providing an adhesion enhancing film between the reflecting film and the base material. Moreover, two or more reflection improving films may be formed on the surface of the reflecting film. The reflection improving film may be formed by, for example, by forming at least a first transparent dielectric layer having a high refractivity index and a second transparent dielectric layer having a low refractivity index one on another in this order on the surface of the reflecting film, although the order of forming the layers is not limited to this. Further, transparent dielectric layers having high refractivity index and low refractivity index may be formed (for example, transparent dielectric layer having high refractivity index and transparent dielectric layers having low refractivity index may be formed alternately) on the surface of the second transparent dielectric layer. Number of the reflection improving films to be formed is preferably five or less for economical consideration.

A case of forming the adhesion enhancing film, the reflecting film containing silver and the reflection improving film are formed one on another in this order on the plastic base material will now be described. This applies also to a case where only the reflecting film is formed, a case where the adhesion enhancing film and the reflecting film are formed, and a case where the reflecting film and the reflection improving film are formed.

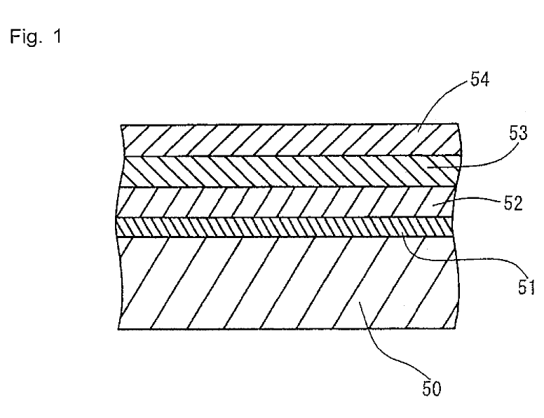

In a preferred embodiment of the present invention, as shown in FIG. 1, the adhesion enhancing film 51 formed from at least one kind selected from Cr, CrO, Cr₂O₃, Y₂O₃, LaTiO₃, La₂Ti₃O₈, SiO₂, TiO₂ and Al₂O₃, the reflecting film 52 containing silver and the reflection improving film including the first transparent dielectric layer 53 and the second transparent dielectric layer 54 which are formed from a compound selected from a group consisting of Y₂O₃, MgF₂, LaTiO₃, La₂Ti₃O₈, SiO₂, TiO₂ and Al₂O₃ are formed one on another in this order from the base material 50 side.

The adhesion enhancing film 51 has the functions to improve the adhesion between the reflecting film 52 and the plastic base material 50 and effectively preventing water from permeating the plastic base material 50 to make contact with the reflecting film 52 and corroding the reflecting film 52. Thickness of the adhesion enhancing film 51 is preferably from 10 to 200 nm, preferably from 30 to 80 nm, in consideration of bonding performance. When thickness of the adhesion enhancing film 51 is less than 10 nm, adhesion becomes weak and it becomes difficult to effectively prevent water from permeating the plastic base material 50 to make contact with the reflecting film 52. It is desirable that the adhesion enhancing film 51 is as thin as possible, as long as satisfactory adhesion is achieved, and therefore thickness of the adhesion enhancing film 51 is preferably not larger than 200 nm.

An SEM photograph taken in Example to be described later shows that the adhesion enhancing film 51 also has the effect of giving more smoothness to the surface of the plastic base material 50 which is porous having numerous microscopic cracks. While the mechanism which achieves this effect is not known, some chemical or physical interaction is supposed to work between the components of the adhesion enhancing film 51 and the surface of the plastic base material 50. In any case, as the surface of the plastic base material 50 becomes smoother, reflectivity of the reflecting film can be improved.

Thickness of the reflecting film 52 containing silver is preferably from 100 to 200 nm and more preferably from 70 to 130 nm. When the thickness is less than 100 nm, the reflecting film 52 allows light to transmit therethrough, thus resulting in lower reflectivity. When thickness of the reflecting film 52 exceeds 200 nm, on the other hand, reflectivity does not increase while a larger quantity of silver increases the material cost, and therefore unnecessarily larger thickness of the reflecting film 52 is not desirable.

The first transparent dielectric layer 53 and the second transparent dielectric layer 54 constitute a high-reflectivity film based on multi-layer interference, namely the reflection improving film. Accordingly, thicknesses of these layers are determined by the refractive index of the material and the wavelength of light. Refractive index of the second transparent dielectric layer 54 is larger than refractive index of the first transparent dielectric layer 53. For example, in case the first transparent dielectric layer 53 is formed from MgF₂ and the second transparent dielectric layer 54 is formed from La₂Ti₃O₈ and it is intended to achieve maximum reflectivity in visible light region, it is determined that the first transparent dielectric layer 53 is about 73 nm and thickness of the second transparent dielectric layer 54 is about 60 nm.

The reflection improving film constituted from the first transparent dielectric layer 53 and the second transparent dielectric layer 54 also has the effect of protecting the reflecting film 52, by preventing the moisture included in the atmosphere from making contact with the reflecting film 52 and corroding the reflecting film 52.

Surface X ray diffraction analysis of the reflecting film 52 containing silver shows that (111) peak intensity on the first transparent dielectric layer 53 side is 20 times or more as high as the sum of other peaks. This means that the reflecting film has a high degree of crystal orientation and high crystal density, and shows uniform property. This makes it possible to suppress the absorption of light in the film and the scattering of light which are major causes of the decrease in reflectivity. Absorption of light is a process in which the energy of light is converted into heat in the film, which occurs when the film has a defect such as impurity therein.

Observation of the reflecting film 52 by an atomic force microscope (AFM) shows arithmetic mean surface roughness is 3 nm (0.003 μm) or less. The atomic force microscope is a microscope which is capable of visualizing the surface irregularity on the order of nanometers, by measuring the deflection of a cantilever due to inter-atomic force using the reflection of laser beam, when the cantilever carrying a probe is brought to near the surface a specimen. The surface roughness measured by the atomic force microscope being 3 nm or less means that the reflecting film 52 is substantially flat. This leads to suppression of the scatter of light on the surface of the layer which is a major cause of decrease in reflectivity.

From the above discussion, it is believed that high density and flatness of the reflecting film 52 achieve high reflectivity while suppressing the absorption and scatter of light.

The second transparent dielectric layer 54 has arithmetic mean surface roughness of 5 nm or less on the surface thereof opposite to the base material 50. As a result, flatness of the second transparent dielectric layer 54, together with the reflecting film 52, suppresses scatter and absorption of light and contributes to achievement of high reflectivity.

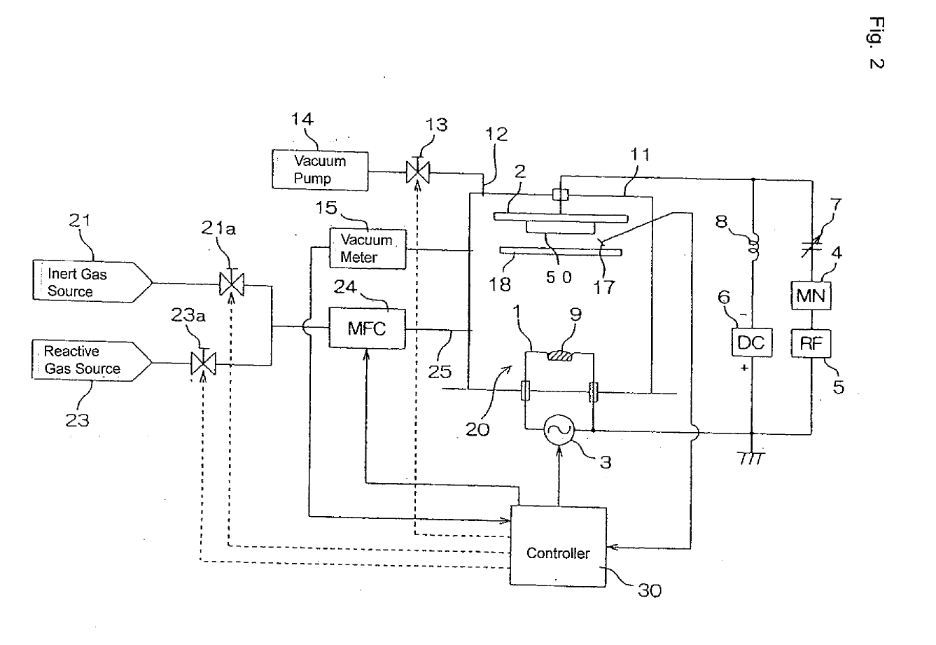

Next, a method of manufacturing the reflecting mirror will now be described. FIG. 2 schematically shows a thin film forming apparatus used to manufacture the reflecting mirror. With this method of forming the thin film, it is made possible to continuously form the film on the plastic base material 50 with one thin film forming apparatus, by varying the evaporation material 9 and, when required, the film forming conditions.

A case of forming the adhesion enhancing film 51 on the surface of the plastic base material 50 will first be described. In the thin film forming apparatus shown in FIG. 2, an evaporation source 20 comprising an evaporation material 9 held in a boat 1 is placed at the bottom of a chamber 11. Disposed at an upper position in the chamber 11 is a base material holding section 2 for holding the base material 50 so as to oppose the evaporation source 20. The evaporation material 9 used to form the adhesion enhancing film 51 may be LaTiO₃, La₂Ti₃O₈, SiO₂, TiO₂ or Al₂O₃.

The base material holding section 2 is formed from an electrically conductive material and is subjected to high-frequency electric power supplied from the high frequency power source (RF) 5 via a matching device (MN) 4 and a capacitor 7 serving as a DC component cut filter. The capacitor 7 may be a variable capacitor which also serves as a part of matching circuit. Connected to the base material holding section 2 is a negative electrode of a DC voltage source (DC) 6 via a coil 8 which serves as a high-cut filter. A terminal of the high frequency power source 5 opposite to the base material holding section 2 is connected to a positive electrode of the DC voltage source 6 and is grounded.

The boat 1 is formed from, for example, a material having high electrical resistance, and receives electric power from a heating power source 3 which is a DC power source so as to generate heat for evaporating the evaporation material 9. Also connected to the boat 1 is the positive electrode of the DC voltage source 6.

Air in the space within the chamber 11 is evacuated by a vacuum pump 14 via an exhaust duct 12 and an exhaust valve 13, so as to achieve a predetermined level of vacuum during the period of forming the thin film. The chamber 11 is connected to an inert gas source 21 and a reactive gas source 23 via a flow control device (MFC) 24 and a gas supply pipe 25 for supplying an inert gas (such as argon gas) and a reactive gas (such as oxygen gas) into the chamber 11. Gas from the inert gas source 21 is supplied or stopped by opening or closing a valve 21a. Gas from the reactive gas source 23 is supplied or stopped by opening or closing a valve 23a.

Level of vacuum in the chamber 11 is measured by a vacuum meter 15, and the flow control device 24 is controlled by a controller 30 comprising a microprocessor or the like according to the output of the vacuum meter 15. Thus quantities of gases supplied from the inert gas source 21 and the reactive gas source 23 are controlled so as to maintain the predetermined level of vacuum in the chamber 11. Vacuum level in the chamber 11 when forming the adhesion enhancing film 51 is preferably in a range from 1.0×10⁻² to 5.0×10⁻² Pa, more preferably in a range from 2.0×10⁻² to 3.0×10⁻² Pa. At this time, concentration of the oxygen gas is controlled in a range from 1.0×10⁻² to 3.0×10⁻² Pa.

To monitor the rate of forming the thin film on the surface of the plastic base material 50, a film thickness monitor 17 is provided in association with the base material holding section 2. Output signal of the film thickness monitor 17 is input to the controller 30, while the controller 30 controls the output power of the heating power source 3 according to the output from the film thickness monitor 17. Power supply to the boat 1 is thus controlled so as to achieve the desired rate of forming the thin film through the control of the evaporation rate of the evaporation material 9. To obtain the adhesion enhancing film 51 which is a metal oxide film, the rate of forming the metal oxide film is preferably from 5 to 20 Å per second, more preferably from 13 to 18 Å per second.

The high frequency power source 5, which may be a high frequency power source operating at frequencies ranging from 10 to 50 MHz, may be set to 13.56 MHz as in the common practice, and supplies high frequency power of 50 to 800 mW, preferably 85 to 170 mW per unit area (cm²) of the base material holding section 2 which serves as a discharge electrode. This generates a corresponding high frequency electric field in the chamber 11, so that plasma is generated in the chamber 11 from the gas supplied from the gas supply pipe 25 and the vapor evaporated from the evaporation material 9. Among ionized particles of the plasma, those positively charged are attracted toward the surface of the base material 50 due to the DC bias applied from the DC voltage source 6 to the base material holding section 2. The voltage applied from the DC voltage source 6 is from 100 to 400 V, preferably from 180 to 230 V.

On the other hand, dissociated electrons of the plasma are attracted toward the boat 1 which is connected to the positive electrode of the DC voltage source 6. At this time, since the evaporation material 9 of the evaporation source 20 evaporates continuously, an illuminating body appears in the vicinity of the evaporation source 20 in such a shape that looks like a leg of the plasma coming down to the evaporation source 20, due the collision of the evaporated particles and electrons. The electrons gathered in the vicinity of the evaporation source 20 are drawn into the boat 1 which is grounded and connected to the positive electrode, so as to collide with the evaporation material 9 held on the boat 1. As a result, evaporation of the evaporation material 9 is accelerated by the heat supplied from the boat 1 and the collision of electrons. In other words, an effect of accelerating the evaporation at a low temperature by concentrated bombardment of the evaporation material 9 with electrons (deposition assist effect) is achieved.

As can be seen from FIG. 2, the chamber 11 is neither connected to either the DC voltage source 6 or the high frequency power source, nor grounded, that is, the chamber 11 is electrically floated. As a result, high frequency discharge does not occur between the base material holding section 2 and the chamber 11, and charged particles of the plasma in the chamber 11 are not attracted toward the inner wall of the chamber 11. Thus cations and positively charged particles of the plasma in the chamber 11 are efficiently guided to the surface of the base material 50, while the negatively charged particles, namely electrons, of the plasma are guided to and concentrated in the evaporation material 9 held on the boat 1. This makes it possible to form a satisfactory thin film and efficiently accelerate the evaporation of the evaporation material 9 by means of electron beam. Moreover, the evaporation material can be suppressed from depositing on the inner wall of the chamber 11.

When the plasma is stabilized in the chamber 11, irradiation of the evaporation material 9 with the electron beam from the plasma causes the evaporation material 9 to evaporate as if it is sucked up by the plasma. Then the controller 30 decreases the output power of the heating power source 3 in accordance to the output of the film thickness monitor 17, so as to maintain a constant rate of deposition of the evaporation material 9 on the base material 50. That is, current supplied or voltage applied to the boat 1 is decreased, thereby controlling the rate of evaporation.

Since evaporation of the evaporation material 9 is accelerated by the electron beam supplied from the plasma, electric current supplied to heat the boat 1 can be kept at a low level. As a result, evaporation of the evaporation material 9 can be maintained at a relatively low heating temperature, thereby forming the thin film through deposition by the action of plasma.

Formation of the thin film in this apparatus is characterized by the method of supplying the inert gas to the chamber 11. That is, in the early stage of forming the thin film, the gas is supplied from the gas supply pipe 25 at a relatively large flow rate to the chamber 11. When evaporation of the evaporation material 9 becomes vigorous, the gas supply from the gas supply pipe 25 is decreased. Thus in the early stage of forming the thin film when evaporation of the evaporation material 9 is at a low level, plasma is formed in the chamber 11 from the inert gas supplied from the gas supply pipe 25. When evaporation of the evaporation material 9 becomes vigorous, the gas supply from the gas supply pipe 25 is decreased so that plasma of such a constitution is formed in the chamber 11 as the particles evaporated from the evaporation material 9 become dominant.

Thus stable plasma can be quickly formed in the chamber 11 by introducing the inert gas into the chamber 11 in the early stage of forming the thin film. Accordingly, since thin film formation by the action of plasma can be carried out in the early stage, the adhesion enhancing film 51 which is a thin film having good adhesion property can be formed on the surface of the base material 50.

FIG. 3 is a diagram explanatory of more specific process of forming the thin film. This drawing shows an example of the process of forming the thin film on the base material 50 while supplying the inert gas from the inert gas source 21 into the chamber 11. Specifically, FIG. 3(a) shows the change in the quantity of gas supplied with time, FIG. 3(b) shows the change in the level of vacuum in the chamber 11 with time and FIG. 3(c) shows the change in the electrical current supplied to heat the boat 1 with time.

In a period Ti prior to the start of the thin film forming process, the controller 30 opens the exhaust valve 13 so that the air in the chamber 11 is evacuated by the vacuum pump 14 and the level of vacuum in the chamber 11 is maintained at, for example, about 10⁻³ Pa. From this state, the controller 30 opens the valves 21a, 23a at time t10, and starts the supply of gases from the inert gas source 21 and the inert gas source 23. Once the gas supply is started, the controller 30 controls the flow control device 24 so as to keep the level of vacuum in the chamber 11 at, for example, about 2.0×10⁻² Pa by monitoring the output signal from the vacuum gage 15.

Thus in a period T2 during which power supply to the boat 1 is started to heat the evaporation source 9, plasma is generated in the chamber 11 by the high frequency electric field applied by the high frequency power source 5. Atoms and molecules of the ionized inert gas in the plasma are guided to the base material 50 by the DC bias applied to the base material holding section 2 by the DC voltage source 6. In case the base material 50 is heated to an undesirably high temperature by the collision of atoms and molecules of the inert gas with the base material 50 during the period T2, a shutter 18 may be provided below the base material 50 so as to block the inert gas from reaching the base material 50.

In the period T2, the controller 30 controls the heating power source 3 to start power supply to the boat 1. Thus, the current supplied to heat the boat 1 is increased to, for example, 150 A at the end of the period T2. At time t11 when the plasma in the chamber 11 has been stabilized, the shutter 18 is opened by a drive device (not shown) which is controlled by the controller 30, so that formation of the thin film is started. As the evaporation material 9 evaporates, vapor particles are introduced into the plasma. Therefore, level of vacuum in the chamber 11 becomes lower if the gas is supplied from the gas supply pipe 25 at a constant flow rate into the chamber 11.

The controller 30, however, controls the flow control device 24 so as to maintain the inside of the chamber 11 at a constant level of vacuum (for example, 2.0×10⁻² Pa) and controls the quantity of gas supplied via the gas supply pipe 25. As a result, quantity of the inert gas introduced into chamber 11 decreases as indicated by reference letter A as the evaporation of the evaporation material 9 increases. Therefore, composition of the plasma is governed by the inert gas in the early stage of period T3 in which the thin film is formed, but quickly shifts to one that is governed by the vapor of the evaporation material 9. In order to obtain the adhesion enhancing film 51, since quantity of the inert gas introduced into chamber 11 decreases as indicated by reference letter A as the evaporation of the evaporation material 9 increases, such a control is carried out as the quantity changes with time as indicated by reference letter C. Also the quantity of oxygen gas introduced into chamber 11 increases as the evaporation of the evaporation material 9 increases.

Since the evaporation of the evaporation material 9 is accelerated by the supply of electrons from the plasma, electrical current supplied to the boat 1 by the heating power source 3 is decreased as indicated by reference letter B through feedback control according to the output from the film thickness monitor 17. For example, current is decreased from 150 A to 80 A after a period of about 2 to 3 seconds. As a result, evaporation of the evaporation material 9 proceeds at a temperature lower than in the case of ordinary vapor deposition or ion plating process, and therefore there is no possibility of the base material 50 to be overheated by the radiation from the evaporation source 20.

According to this embodiment, as described above, satisfactory plasma can be formed in the chamber 11 from the early stage of the thin film forming process, by starting the thin film forming process with the inert gas having been introduced into the chamber 11. This enables it to guide the evaporation material efficiently to the base material 50 under the action of the plasma from the early stage of the thin film forming process. As a result, the adhesion enhancing film 51 constituted from at least one kind selected from among LaTiO₃, La₂Ti₃O₈, SiO₂, TiO₂ and Al₂O₃ can be formed efficiently.

After the adhesion enhancing film 51 has been formed, silver-based material is placed as the evaporation material 9 in the boat 1 of the evaporation source 20, and a silver layer is formed on the surface of the adhesion enhancing film 51 which is provided on the base material 50, so as to obtain the reflecting film 52 similarly to the formation of the adhesion enhancing film 51. At this time, the reactive gas source 23 which supplies the reactive gas such as oxygen is not used. To form the reflecting film 52 from silver, level of vacuum in the chamber 11 is set in a range from 1.0×10⁻² to 5.0×10⁻² Pa, preferably from 2.5×10⁻² to 3.5×10⁻² Pa, and the rate of forming the reflecting film 52 is from 10 to 20 Å per second, preferably from 15 to 18 Å per second.

After the reflecting film 52 has been formed from silver, MgF₂ or SiO₂ is placed as the evaporation material 9 in the boat 1, and the first transparent dielectric layer 53 is formed from MgF₂ or SiO₂ on the surface of the surface of the reflecting film 52 similarly to the formation of the adhesion enhancing film 51.

Then LaTiO₃, La₂Ti₃O₈, SiO₂, TiO₂ or Al₂O₃ is used as the evaporation material 9, so as to form the second transparent dielectric layer 54 from at least one kind selected from among LaTiO₃, La₂Ti₃O₈, SiO₂, TiO₂ and Al₂O₃ on the surface of the first transparent dielectric layer 53 similarly to the formation of the adhesion enhancing film 51.

The evaporation materials 9 may be supplied to the boat 1, also by supplying the materials used to form the adhesion enhancing film 51, the reflecting film 52, the first transparent dielectric layer 53 and the second transparent dielectric layer 54 in this order to the boat 1 from a coating material supplier (not shown), and evaporating the materials under predetermined film forming conditions so as to form the film consecutively on the base material 50.

While these thin films are being formed, the base material 50 is maintained at a temperature not higher than 60° C., which is advantageous in forming the films (layers) 51 through 54 on the surface of the plastic base material 50. For example, since polycarbonate has heat resistance at a temperature of 120 to 130° C. and polymethyl-methacrylate has heat resistance at a temperature of about 80° C., for example, the films (layers) 51 through 54 can be formed successively on the surface of the plastic base material 50 which is formed from such a plastic material.

According to the thin film forming method, since the gases for forming the plasma are supplied into the chamber 11, plasma can be formed quickly in the chamber 11 in the early stage of the thin film forming process. This enables it to form the films (layers) 51 through 54 by making use of the action of the plasma from the early stage of the thin film forming process, so as to obtain the reflector having high boding performance and high durability.

Also because the flow rate of the gas supplied into the chamber 11 is set higher in from the early stage of the thin film forming and lower thereafter, the base material 50 can be suppressed from being heated to an undesirably high temperature by the collision of atoms and molecules of the inert gas with the base material 50.

In addition, cations and positively charged particles of the plasma are accelerated by the DC electric field applied by the DC voltage source 6 to move toward the base material 50 so as to collide with and deposit on the surface of the base material 50. Thus the coating film is formed. The negatively charged particles, namely electrons, are accelerated toward the boat 1 which has positive potential and are concentrated so as to collide with the evaporation material 9 held on the boat 1, thus imparting the energy for evaporation to the evaporation material 9. The evaporation material 9 which has received a large amount of energy instead of thermal energy can easily evaporate at a low temperature, with the vapor entering the plasma forming region of the chamber 11. That is, the deposition assist effect is achieved wherein electrons of the plasma formed in the chamber 11 are guided toward the evaporation material 9 so as to accelerate the evaporation of the material. Thus the energy used to heat the evaporation material 9 through ohmic heating or the like can be greatly reduced. As a result, temperature of the plastic base material can be suppressed from rising and therefore the thin films can be formed at lower temperatures.

The rate of evaporation from the evaporation material 9 is controlled by regulating the energy supplied to the heating means and the output of the DC voltage source 6 within the ranges described above. Energy imparted by the particles of the evaporation material 9 to the base material 50 is controlled by regulating the output of the DC voltage source 6 within the range described above. This makes it possible to provide the evaporation material with sufficient energy to reorient the atoms or molecules of the evaporated material layer formed on the surface of the base material 50 in an orderly arrangement, rather than simply depositing on the surface of the base material 50. Moreover, the particles of the evaporation material can also be provided with sufficient energy to infiltrate the base material 50 and assimilate therein.

Thus according to the present invention, the films 51 through 54 which are flat with no defects existing in the film and have high density and high adhesion property can be obtained, and a silver film constituted from single crystal of almost pure silver can be formed in the case of the reflecting film 52.

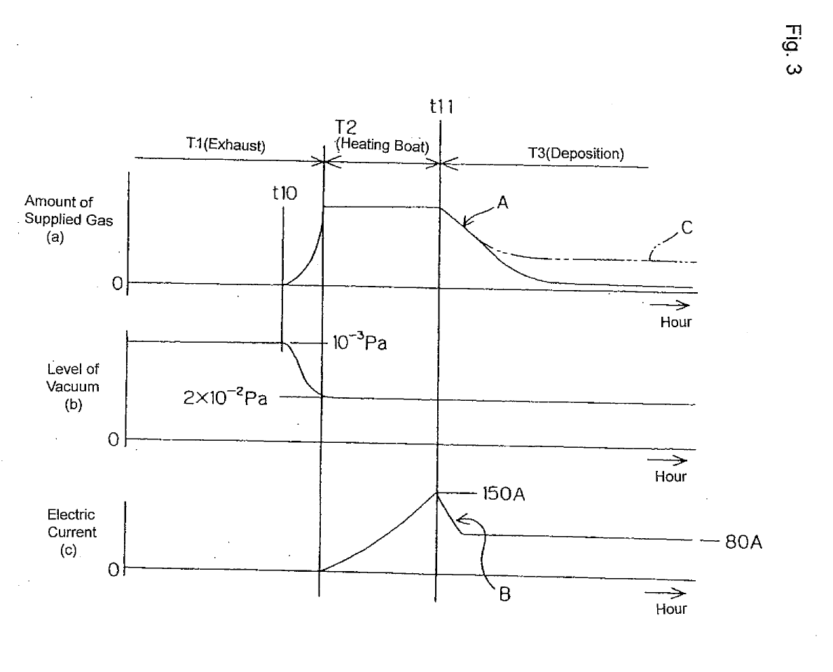

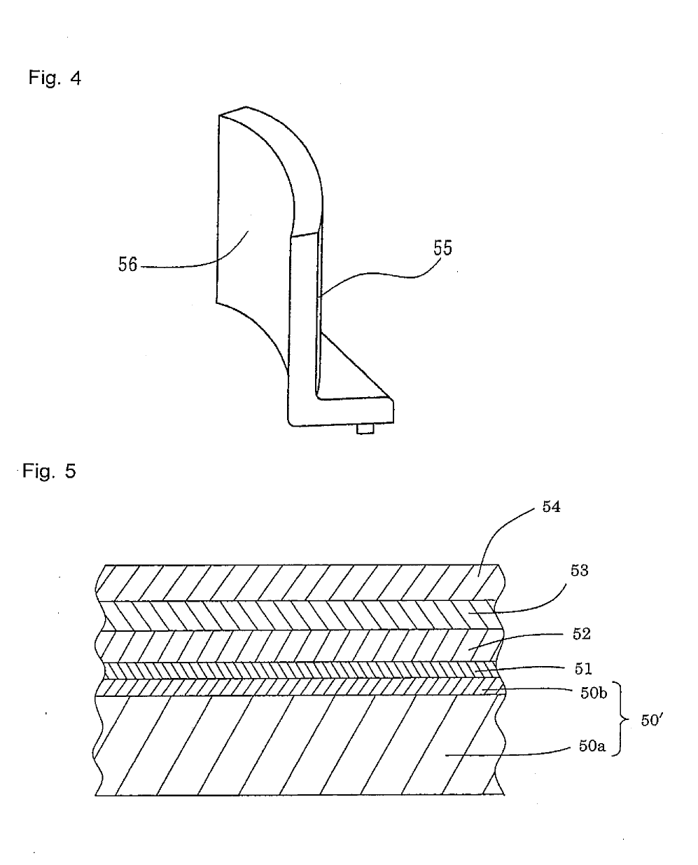

There are no limitations on the shape of the base material in the present invention. Therefore, the reflecting film 56 of silver having the multi-layer constitution of the films 51 through 54 can be formed directly on the surface of the base material 55 having such as complicated shape as shown in FIG. 4. The present invention is also preferably applied to the manufacture of aspherical mirror or the like.

The reflecting film containing silver according to the present invention has a constitution of single crystal having good crystal orientation (aligned in one direction) and has advantages as described below.
(1) High reflectivity of 96% or higher for light in a band of wavelengths ranging from 420 to 700 nm (visible light region).
(2) Reflectivity undergoes small variation of 0.5% or less over incident angle of 10 to 50°.
(3) Satisfactory adhesion with the plastic base material and the like.
(4) Less corrosion and greatly improved durability due to the good adhesion performance.

Thus such a reflecting film containing silver is formed on the plastic base material 50 that is substantially flat with very small surface roughness having constitution of very good single crystal having good crystal orientation. At this time, while the reflecting film has a surface that directly reproduces the surface condition of the plastic base material 50, the plastic base material 50 of the present invention has smooth surface with PV value not larger than 0.5 μm without sharp protrusions, so that the high reflectivity of the reflecting film is not compromised and reflectivity of 96% or higher can be achieved.

Excellent properties of the light reflector of the present invention can preferably used in such applications as described below.

A. Reflecting mirror for liquid crystal projector High reflectivity is obtained for every color with a single reflector without need to manufacture three reflectors for the three primary colors of blue, green and red as in the reflector comprising reflecting layer formed from aluminum.

B. Light tunnel for DLP projector (an optical component having silver film and transparent dielectric layer formed on the inner surface of base material having rectangular tube shape).

C. Reflector of telescope for astronomical observation and binocular

D. Replacement for reflecting mirror using aluminum reflecting layer of various optical instruments

E. Deformed mirror of high reflectivity made by forming a reflecting film on a deformed plastic base material having predetermined surface irregularities formed by molding, taking advantage of the fact that the base material is made of plastics.

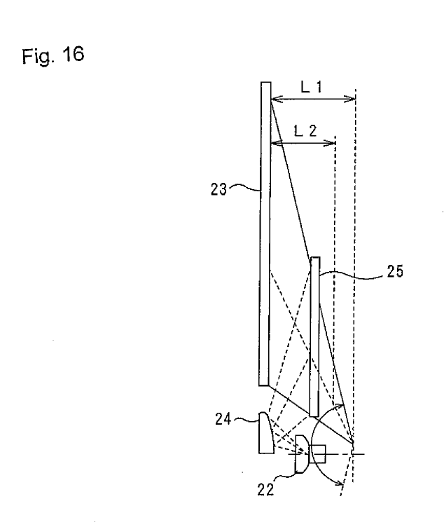

Next, the light reflector of the present invention will now be described, taking a case of applying to the projector as an example. The projector according to the present invention comprises a projection lens used to project modulated light emitted by a spatial modulation element such as liquid crystal display element, the light reflector of the present invention and a transmission screen which receives the light reflected by the reflector. The rear projection type projector may have such constitutions as shown in FIG. 15 and that shown in FIG. 16.

That is, in the rear projection type projector shown in FIG. 15, the rear mirror 21 is disposed in a housing, and an image generated by the optical engine 22 is reflected on the rear mirror 21 and displayed on the screen 23. In the vertical projection system, projecting distance L1 becomes 900 mm or more with projection angle of 80°, and therefore depth L2 of the projector is 500 mm or more.

In the rear projection type projector having reduced depth which has been recently proposed, an image produced by an optical engine 22 is projected obliquely by means of aspherical mirror 24, the image being reflected on the rear mirror 25 and is displayed on the screen 23. This constitution makes it possible to achieve an extremely large projection angle of 160° with the projecting distance L1 of 200 mm, thus enabling it to decrease the depth L2 of the projector to 200 mm or less. Pluralities of plane mirrors and aspherical mirrors may also be used whereon the image is reflected successively, depending on the constitution of the projector. This requires mirror having high reflectivity, and the light reflector of the present invention can be preferably used as the aspherical mirror 24 and the rear mirror 25 of the projector.

### Second Embodiment

The light reflector of this embodiment is constituted from the plastic base material 50 including the reinforced plastic layer 50a and the glossy plastic layer 50b, with the reflecting film 52 formed on the glossy plastic layer 50b, as shown in FIG. 5.

The reinforced plastic layer 50a and the glossy plastic layer 50b are preferably formed from thermosetting resin when the thermal deformation temperature is taken into consideration. There is no restriction on the thermosetting resin as long as the thermal deformation temperature of the molded article is 130° C. or higher. For example, various thermosetting resins may be used such as unsaturated polyester resin, epoxy resin, phenol resin and melamine resin may be used. Especially unsaturated polyester resin is used preferably for the reason of the performance of transferring the shape and dimensional stability of the molded article.

In case unsaturated polyester resin is used, the thermosetting resin composition used in forming the reinforced plastic layer preferably consists of 7 to 19% by mass of an unsaturated polyester resin, 6 to 19% by mass of a thermoplastic resin, 50 to 78% by mass of an inorganic filler, 8 to 20% or less by mass of reinforcing fibers and 0.1 to 3% by mass of a curing agent. Inclusion of the reinforcing fibers with concentration from 8 to 20% by mass increases the strength. When the content of the reinforcing fibers is less than 8% by mass, desired level of strength cannot be obtained. When the content of the reinforcing fibers is more than 20% by mass, the resin has lower fluidity which makes it difficult to mold.

The thermosetting resin composition used in forming the glossy plastic layer 50b preferably consists of 7 to 19% by mass of an unsaturated polyester resin, 6 to 19% by mass of a thermoplastic resin, 70 to 84% by mass of an inorganic filler, 5% or less by mass of reinforcing fibers and 0.1 to 3% by mass of a curing agent. Inclusion of the reinforcing fibers with concentration not higher than 5% by mass makes the surface of the base material 50′ smoother with gloss, so that a high reflectivity can be obtained when the reflecting film is formed by vapor deposition on the surface of the glossy plastic layer 50b. When the content of the reinforcing fibers is higher than 5% by mass, the surface becomes less smooth and the PV (peak-to-valley) roughness exceeds 0.5 μm, thus making it difficult to make the molded article having smooth surface without sharp protrusions, and high reflectivity cannot be obtained. The content of the reinforcing fibers in the glossy plastic layer 50b may be 0% by mass.

The reinforcing fibers may be, for example, glass fiber, carbon fiber, graphite fiber, aramid fiber, silicon carbide fiber, alumina fiber, boron fiber, steel fiber, amorphous fiber or organic fiber, which may be used individually or in a combination of two or more kinds thereof. The reinforcing fiber is preferably 1 to 3 mm in length and 5 to 100 μm in diameter. Longer fibers may compromise the surface smoothness of the glossy plastic layer 50b.

To manufacture the light reflector of the present invention, the reinforced plastic layer 50a containing 8 to 20% by mass of a reinforcing fibers and the glossy plastic layer 50b containing 5% or less by mass of reinforcing fibers are molded successively so as to make the plastic base material 50′, and the reflecting film is formed by vapor deposition on the surface of the glossy plastic layer 50b of the base material 50′. There is no restriction on the order of molding, and either the reinforcement layer 50a or the gloss layer 50b may be molded first.

While the plastic base material 50′ may be made by molding the reinforcement layer 50a and the gloss layer 50b individually and then placed one on another and integrated by bonding or the like, it is preferable to mold these layers successively in a single mold. Specifically, for example, the thermosetting resin composition for the reinforcement layer is poured into the mold so as to mold the reinforcement layer 50a and, without removing it from the mold, the thermosetting resin composition for the gloss layer is poured into the mold so as to mold the gloss layer 50b.

The second stage of molding (molding of the gloss layer) is preferably carried out while degassing, in order to prevent air from being trapped in the resin. This enables it to improve the adhesion between the reinforcement layer 50a and the gloss layer 50b and achieve high adhesion strength. The thermosetting resin composition for the second stage of molding may be poured into the mold at a time when at least the first stage of molding (curing of the resin) has completed.

The thermosetting resin composition is molded by heating it to a temperature from 135 to 180° C. so as to cure. Methods of molding commonly employed in molding of thermosetting resin may be employed such as injection molding, transfer molding and compression molding.

It is preferable that the glossy plastic layer 50b is thinner than the reinforced plastic layer 50a. In case the glossy plastic layer 50b is thicker than the reinforced plastic layer 50a, the base material 50 may not be made strong enough. Specifically, the glossy plastic layer 50b is preferably about 0.1 to 0.9 times as thick as the reinforced plastic layer 50a.

It is also preferable that difference in linear expansion coefficient between the reinforced plastic layer 50a and the glossy plastic layer 50b is 3×10⁻⁵/° C. or less. Difference in linear expansion coefficient larger than 3×10⁻⁵/° C. may cause cracks between the reinforced plastic layer 50a and the glossy plastic layer 50b when the ambient temperature changes. In order to keep the difference in linear expansion coefficient within the range described above, the members may be formed from resins having the same compositions except for the content of the reinforcement fibers.

The mold used in molding is required to be smooth on the surface thereof corresponding to the reflecting film forming surface of the molded article. Specifically, the mold has surface roughness Rz of 0.5 μm or less and preferably 0.4 μm or less as defined in JIS B 0601-2001. The 2-stage molding may be carried out by various methods, such as separate molding using two molds, use of a mold which has two cavities of different shapes, or a process comprising a first stage of molding using one cavity in the mold followed by a second stage of molding with the cavity space being expanded mechanically by means of a hydraulic device or a motor.

The method using a mold which has two cavities of different shapes includes (1) the process of using a partition to mold either the reinforcement layer or the gloss layer followed by molding of the other layer with the partition removed by means of a hydraulic device or a motor, and (2) a process where either the reinforcement layer or the gloss layer is molded in one of two cavities of different shapes formed in an upper mold, then the mold is opened with the lower mold or the upper mold being offset by sliding or rotating and molding the other layer over the layer which has been molded, using the other shape.

Degassing, which is required when 2-stage molding is carried out using one mold, may be carried out by such methods as, for example, a gas vent is provided in the mold to allow gas to escape, inside of the mold is evacuated to decrease the pressure, a mold sliding mechanism is used to purge the gas through the gas between the mold and the slide, or the gas is purged by using an ejector pin provided to eject the molded article. By degassing the mold, the gas remaining in the mold is purged so as to improve the performance of transferring the shape from the mold to the resin.

The plastic base material which has been molded has smooth surface with PV value not larger than 0.5 μm without sharp protrusions. Therefore, the reflecting film can be formed directly on the surface of the molded article which has been released from the mold, without post processing such as providing a smoothing layer (such as undercoat layer) on the surface or polishing the surface. At the same time, the surface of the reflecting film which is heavily influenced by the surface of the plastic base material can be made smooth with PV value not larger than 0.5 μm without sharp protrusions.

Next, then the reflecting film containing silver is formed on the surface of the base material thus obtained, similarly to the first embodiment. The process that follows is the same as in the first embodiment, and description thereof will be omitted.

### Third Embodiment

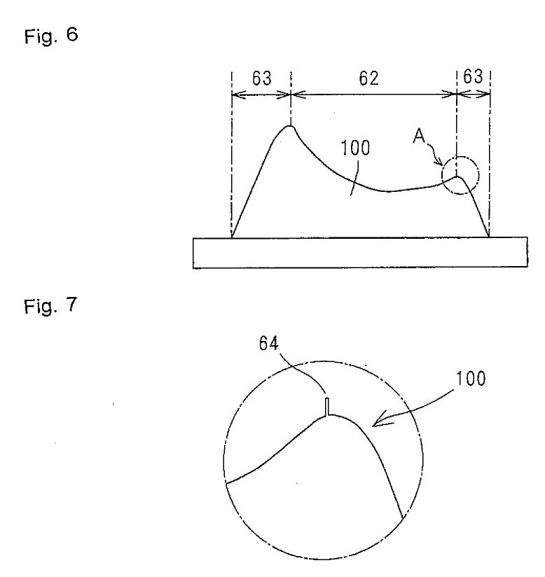

FIG. 6 shows a light reflector 100 for projector according to this embodiment, where the reflecting film has a central portion 62 which serves as the mirror and a peripheral portion 63. The peripheral portion 63 is a surface tilting downward from the central portion 62. A protrusion 64 is formed along the border between the central portion 62 and the peripheral portion 63, or in the peripheral portion 63 near the border, as shown in FIG. 7. The protrusion 64 is provided along the entire circumference of the reflecting film surface so as to surround the central portion 62. FIG. 2 is an enlarged view of the portion A in FIG. 1.

Surface roughness Rz of the central portion 62 is 0.5 μm or less and preferably from 0.05 to 0.4 μm. When the surface roughness Rz of the central portion 62 is larger than 0.5 μm, reflectivity of the central portion 62 becomes lower and makes it difficult to achieve reflectivity of 96% or higher, as will be described later. The reflecting film in the central portion 62 is formed to have smooth surface without sharp protrusions and reflectivity of the reflecting film not lower than 96%.

While there is no limitation on the dimension of the protrusion 64, it is preferably 0.01 to 0.05 mm in height and 0.01 to 0.05 mm in width (especially width at the top). These dimensions enable the protrusion to effectively serve as a dam for protecting the reflecting film from corrosion.

The protrusion 64 is preferably formed in the peripheral portion 63 at the same time as the reinforced plastic layer is molded.

A method for manufacturing the plastic base material having the protrusion 64 formed in the periphery 63 will now be described.

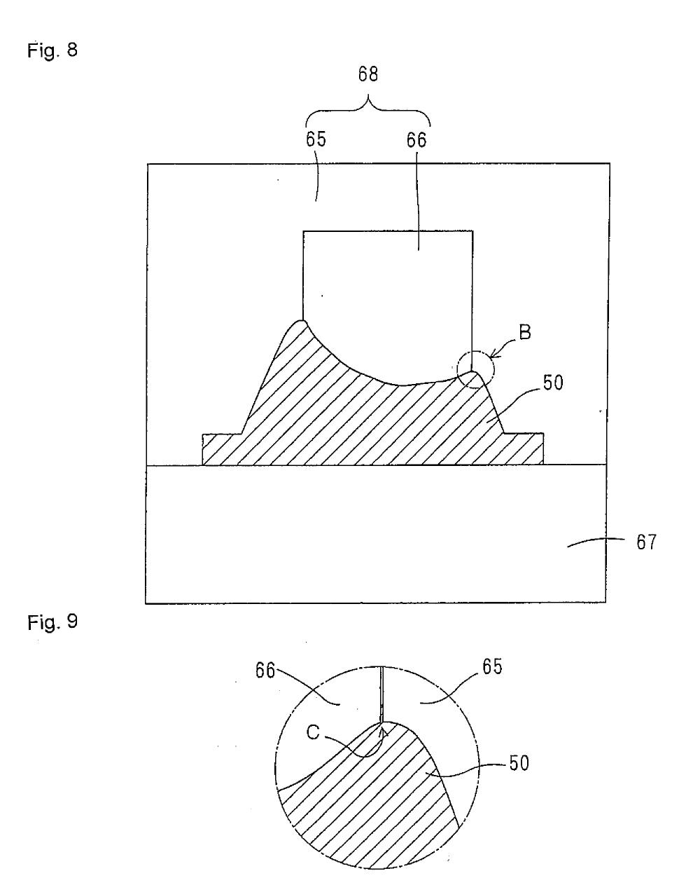

FIG. 8 shows a mold for molding the plastic base materials 50, 50′. The mold comprises a lower mold 67 and an upper mold 68. The upper mold 68 is constituted from a mold member 65 corresponding to the peripheral portion of the plastic base material and a mold member 66 corresponding to the central portion, the mold members 65 and 66 being held together by means of bolt or the like.

Since the central portion 62 reflects the projected light, the corresponding portion of the mold must also have smooth surface. Specifically, the mold has surface roughness Rz of 0.5 μm or less and preferably 0.4 μm or less as defined in JIS B 0601-2001.

The central portion 62 of the base material which has been molded has smooth surface with PV value not larger than 0.5 μm without sharp protrusions.

The protrusion 64 shown in FIG. 7 is formed as a part of the thermosetting resin fills a gap C provided between the mold member 65 and the mold member 66 as shown in FIG. 9.

Width of the gap C is preferably about 0.01 to 0.05 mm. When the width of the gap C is smaller, it may become difficult to provide the protrusion 64 which is effective in protecting the reflecting film from corrosion around the reflecting film. When the width is larger, the protrusion 64 may become too large to apply the pressure required for molding, due to the large quantity of the material which enters therein.

When height of the protrusion is less than that described above, the protrusion cannot prevent corrosion. When height of the protrusion is more than that described above, it may block the optical path of projection.

The plastic base materials 50, 50′ may be constituted from molded article of thermosetting resin when the thermal deformation temperature is taken into consideration. There is no restriction on the molded article of thermosetting resin, as long as the thermal deformation temperature is 130° C. or higher. For example, various thermosetting resins may be used such as unsaturated polyester resin, epoxy resin, phenol resin and polycarbonate. It is particularly preferable to use unsaturated polyester resin.

In case unsaturated polyester resin is used, the thermosetting resin composition preferably consists of 7 to 19% by mass of an unsaturated polyester resin, 6 to 19% by mass of a thermoplastic resin, 70 to 84% by mass of an inorganic filler, 5% or less by mass of reinforcing fibers and 0.1 to 3% by mass of a curing agent, and is molded to make the plastic base material of the predetermined shape.

Then the reflecting film containing silver is formed on the surface of the plastic base material 50 which has been obtained, similarly to the first embodiment, thereby making the light reflector for projector. The process that follows is the same as in the first and second embodiments, and description thereof will be omitted.

### Fourth Embodiment

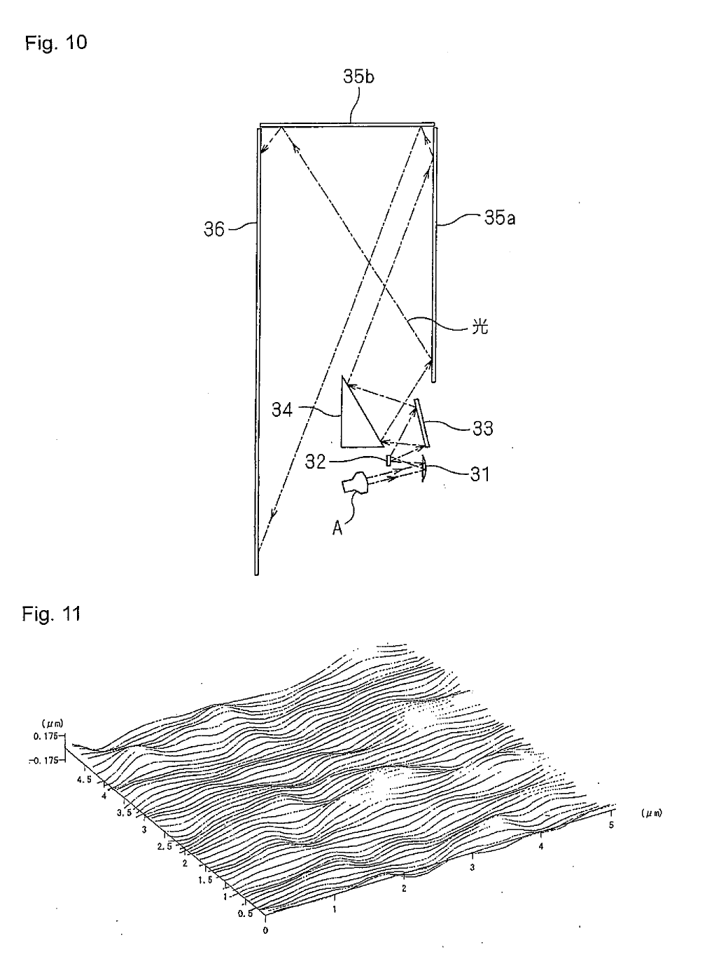

FIG. 10 schematically shows an example of projector according to this embodiment. The projector is a rear projection type projector which is constituted so that light representing an image generated by an image forming element A is reflected on four reflecting mirrors, namely a first reflecting mirror 31, a second reflecting mirror 32, a third reflecting mirror 33 and a fourth reflecting mirror 34 in this order along the direction of light propagation, and is reflected on plane reflecting mirrors 35a, 35b so as to be projected as an enlarged image onto the transmission screen 36.

The image forming element A may be a liquid crystal or DMD (Digital Micromirror Device, registered trade mark of Texas Instrument Inc.).

The first, second, third and fourth reflecting mirrors 31, 32, 33, 34 may be aspherical mirror having such configuration as parabola, hyperbola, cylinder or oval, free curve mirror having freely designed curved surface expressed by a polynomial, spherical mirror or plane mirror. The first and second reflecting mirrors 31, 32 have reflectivity of 96% or higher on the reflecting surface thereof. In the course of magnifying the image successively, the image of high quality with clear contrast can be projected onto the screen 36, since the first and second reflecting mirrors 31, 32 have reflectivity of 96% or higher even when the reflecting mirrors 33, 34 that follow have lower reflectivity.

In case the first and second reflecting mirrors 31, 32 have reflectivity lower than 96%, however, clear image of high quality cannot be obtained even when the reflecting mirrors 33, 34 that follow have reflectivity of 96% or higher.

According to the present invention, reflectivity of the reflecting mirrors 33, 34 that follow may be not lower than 96% or lower than 96%, as long as the first and second reflecting mirrors 31, 32 have reflectivity of 96% or higher. While this embodiment is a projector having the first, second, third and fourth reflecting mirrors 31, 32, 33, 34 and plane mirrors 35a, 35b. However, clear image of high quality can be projected onto the screen 36 if the projector has at least three reflecting mirrors and at least the first and second reflecting mirrors 31, 32 located near the image forming element A have reflectivity of 96% or higher.

The reflecting mirror having reflectivity of 96% or higher is constituted by forming the reflecting film containing silver on the surface of the plastic base material.

The plastic base material may be constituted from molded article of thermosetting resin similar to that of the first through third embodiments when the thermal deformation temperature is taken into consideration. With other respects, this embodiment is similar to of the first through third embodiments, and therefore description thereof will be omitted.

The present invention will now be described below by way of Examples, although the present invention is not limited to these Examples.

### EXAMPLES 1

The following components were mixed in proportions shown in Table 1, and were kneaded in a kneader at the normal temperature thereby to obtain the thermosetting resin composition.
Unsaturated polyester resin: Product name U-PiCA 7123 manufactured by Japan U-PiCA Company, Ltd.
Thermoplastic resin: Product name A-25 manufactured by Japan U-PiCA Company, Ltd.
Inorganic filler: Product name NS-200 from NITTO FUNKA KOGYO K.K.
Curing agent (A): Product name Perhexa HC manufactured by NOF CORPORATION
Curing agent (B): Product name Perbutyl Z manufactured by NOF CORPORATION
Mold releasing agent: Product name Efco-Chem ZNS-P manufactured by ADEKA CORPORATION

TABLE 1

| | Proportion |
|---|---|
| Component | (% by mass) |
| Unsaturated polyester resin | 11.8 |
| Thermoplastic resin | 7.9 |
| Inorganic filler | 78.9 |
| Curing agent (A) | 0.1 |
| Curing agent (B) | 0.3 |
| Mold releasing agent | 1 |

The thermosetting resin composition thus prepared was poured into a mold for compression molding, and compression molding was carried out by using a 50-ton transfer molding machine (manufactured by Ohji Kikai), thereby to obtain the plastic base material having thickness of 2 mm, under the following conditions.
Molding temperature: 165° C.
Mold clamping pressure: 150 kgf/cm²
Injection pressure: 50 kgf/cm²
Curing time: 3 minutes

The light reflector was made by forming the layers (i) through (iv) in order on the plastic base material which was released from the mold, without processing the surface.
(i) Adhesion enhancing film 51: Lanthanum titanate LaTiO₃ (40 nm thick)
(ii) Reflecting film 52: Silver Ag (100 nm thick)
(iii) First transparent dielectric layer 53: Magnesium fluoride MgF₂ (73 nm thick)
(iv) Second transparent dielectric layer 54: Lanthanum titanate La₂Ti₃O₈ (60 nm thick)

The layers were formed under the following conditions.
(i) Adhesion enhancing film 51
Evaporation material 9: Y₂O₃ (purity 99%)
Gas introduced into chamber 11: Argon gas and oxygen gas Voltage applied to the base material holding section 2 from the high frequency power source 5: 85 mW/cm² at frequency 13.56 MHz (power applied per unit area of the base material holding section 2)
DC voltage source 6: Negative electrode is connected to the base material holding section 2 and positive electrode is connected to boat 1.
Voltage applied to the base material holding section 2 from the DC voltage source 6: 230 V
Chamber 11: Electrically floated.
Y₂O₃ layer forming rate: 15 Å/second or less
   (A) Early stage of forming Y₂O₃ layer (period T2 of FIG. 3)
Level of vacuum in chamber 11: Constant at 2×10⁻² Pa Current supplied from the heating power source 3 to the boat 1: 350 A (near end of T2)
   (B) Stage of forming Y₂O₃ layer (period T3 of FIG. 3)

Level of vacuum in the chamber 11: Constant at 2×10⁻² Pa Current supplied from the heating power source 3 to the boat 1: 230 A (near end of T3)

The Y₂O₃ layer having thickness of 40 nm was thus formed on the surface of the base material 50. Surface temperature of the base material 50 was maintained at lower than 40° C. throughout the entire period of forming the thin film.

Current supplied from the heating power source 3 to the boat 1: 230 A (near end of T3)

The LaTiO₃ layer having thickness of 40 nm was thus formed on the surface of the base material 50. Surface temperature of the base material 50 was maintained at lower than 40° C. throughout the entire period of forming the thin film.

### (II) Reflecting Film 52

Evaporation material 9: Silver (purity 99.9%)
Gas introduced into chamber 11: Argon gas
Voltage applied to the base material holding section 2 from the high frequency power source 5: 85 mW/cm² at frequency 13.56 MHz (power applied per unit area of the base material holding section 2)
DC voltage source 6: Negative electrode is connected to the base material holding section 2 and positive electrode is connected to the boat 1.
Voltage applied to the base material holding section 2 from the DC voltage source 6: 230 V
Chamber 11: Electrically floated.
Reflecting film forming rate: 5 to 18 Å/second
(a) Early stage of forming reflecting film (period T2 of FIG. 3)
Level of vacuum in chamber 11: Constant at 2×10⁻² Pa
Current supplied from the heating power source 3 to the boat 1: 280 A (near end of T2)
(b) Stage of forming the reflecting film (period T3 of FIG. 3)
Level of vacuum in chamber 11: Constant at 2×10⁻² Pa
Current supplied from the heating power source 3 to the boat 1: About 210 A (near end of T3)

The reflecting film having thickness of 110 nm was thus formed on the Y₂O₃ layer. Surface temperature of the base material 50 was maintained within a range from about 40 to 45° C. throughout the entire period of forming the thin film, as indicated by a thermo-sensitive seal having reaction temperature of 40° C. showing a slight change.

### (III) First Transparent Dielectric Layer 53

Evaporation material 9: Magnesium fluoride MgF₂ (purity 99.9%)
Gas introduced into chamber 11: Argon gas
Voltage applied to the base material holding section 2 from the high frequency power source 5: 85 mW/cm² at frequency 13.56 MHz (power applied per unit area of the base material holding section 2)
DC voltage source 6: Negative electrode is connected to the base material holding section 2 and positive electrode is connected to the boat 1.
Voltage applied to the base material holding section 2 from the DC voltage source 6: 230 V
Chamber 11: Electrically floated.
MgF₂ layer forming rate: 15 Å/second or less
   (A) Early stage of forming MgF₂ layer (period T2 of FIG. 3)
Level of vacuum in chamber 11: Constant at 2×10⁻² Pa
Current supplied from the heating power source 3 to the boat 1: 350 A (near end of T2)
   (B) Stage of forming MgF₂ layer (period T3 of FIG. 3)
Level of vacuum in chamber 11: Constant at 2×10⁻² Pa Current supplied from the heating power source 3 to the boat 1: 230 A (near end of T3)

The MgF₂ layer having thickness of 54 nm was thus formed on the surface of the reflecting film. Surface temperature of the base material 50 was maintained lower than 40° C. throughout the entire period of forming the MgF₂ layer, as indicated by a thermo-sensitive seal having reaction temperature of 40° C. showing no change.
Then the following process was carried out.
Evaporation material 9: Yttrium oxide Y₂O₃ (purity 99%)
Gas introduced into chamber 11: Argon gas and oxygen gas Voltage applied to the base material holding section 2 from the high frequency power source 5: 85 mW/cm² at frequency 13.56 MHz (power applied per unit area of the base material holding section 2)
DC voltage source 6: Negative electrode is connected to the base material holding section 2 and positive electrode is connected to the boat 1.
Voltage applied to the base material holding section 2 from the DC voltage source 6: 230 V
Chamber 11: Electrically floated.
Y₂O₃ layer forming rate: 15 Å/second or less
   (A) Early stage of forming Y₂O₃ layer (period T2 of FIG. 3)
Level of vacuum in chamber 11: Constant at 2×10⁻² Pa
Current supplied from the heating power source 3 to the boat 1: 350 A (near end of T2)
   (B) Stage of forming Y₂O₃ layer (period T3 of FIG. 3)
Level of vacuum in chamber 11: Constant at 2×10⁻² Pa
Current supplied from the heating power source 3 to the boat 1: 230 A (near end of T3)

The LaTiO₃ layer having thickness of 20 nm was thus formed on the surface of the base material 50. Surface temperature of the base material 50 was maintained at lower than 40° C. throughout the entire period of forming the thin film.

### (IV) Second Transparent Dielectric Layer 54

The La₂Ti₃O₈ layer having thickness of 50 nm was thus formed on the surface of the Y₂O₃ layer similarly to (I) except for using La₂Ti₃O₈ instead of the two layers described above. Surface temperature of the base material 50 was maintained lower than 40° C. throughout the entire period of forming the La₂Ti₃O₈ layer, as indicated by a thermo-sensitive seal having reaction temperature of 40° C. showing no change.

The light reflector made in Example 1 was subjected to the following evaluation tests.

### 1. Surface Condition

Surface condition and PV value of the reflecting film were measured with a non-contact three-dimensional profile measuring instrument (NH-3SP from Mitaka Kohki Co., Ltd.). Result of the measurement is shown in FIG. 11. FIG. 11 shows the three-dimensional surface profile of the reflecting film measured with an object lens having magnifying power of 100 times, from which it can be seen that the reflecting film has a smooth surface without sharp protrusion. This result also shows that the surface height is 0.21 μm at the peak and −0.20 μm at the bottom, which means PV value of about 0.4 μm.

### 2. SEM Observation of Surface

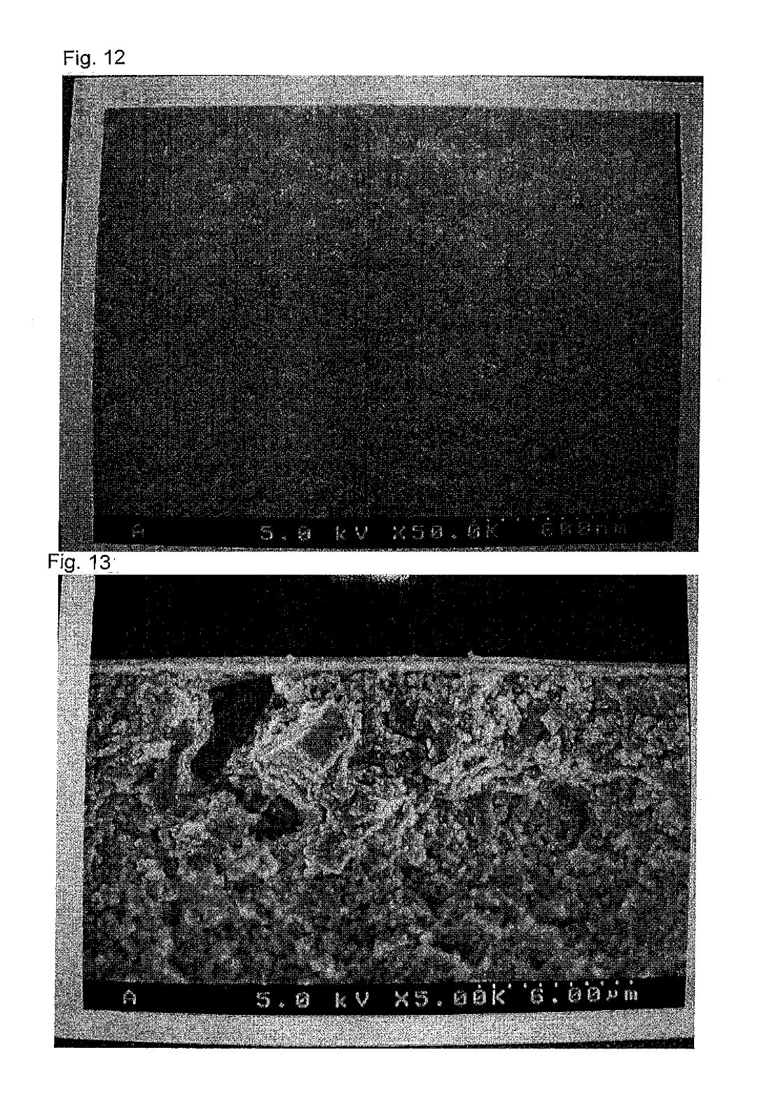

Surface (in oblique direction) and section were observed under an SEM (scanning electron microscope) with 5000 time magnifying power, without the first transparent dielectric layer 53 and the second transparent dielectric layer 54 being formed. The SEM photographs are shown in FIG. 12 and FIG. 13.

### 3. (111) Peak Intensity of X Ray Diffraction

X ray diffraction was measured with an X ray diffraction analyzer (RINT 1400V manufactured by Rigaku Denki Co., Ltd.), with X ray output power of 50 kV-200 mA, measurement angle range 2θ=10°-100°, emission slit—scatter slit—reception slit: 1°-1°-0.3 mm. In the measurement, the reflecting film 52 of the Example showed that (111) peak had an intensity about 23 times the sum of the other peaks.

### 4. Reflectivity

Reflectivity in the visible light region (wavelengths from about 350 to 750 nm) was measured with a luminous intensity meter (spectrophotometer U-4000 manufactured by Hitachi, Ltd.). The measurement showed reflectivity of 98%.

Reflecting mirrors having characteristics similar to those of the Example described above were obtained in a case in which at least one kind selected from Cr, CrO, Cr₂O₃, Y₂O₃, La₂Ti₃O₈, SiO₂, TiO₂ and Al₂O₃ was used as the adhesion enhancing film 51, in a case in which SiO₂, Y₂O₃ was used as the first transparent dielectric layer 53, and in a case in which one selected from a group consisting of La₂Ti₃O₈, SiO₂, TiO₂ and Al₂O₃ was used as the second transparent dielectric layer 54.

### COMPARATIVE EXAMPLE 1

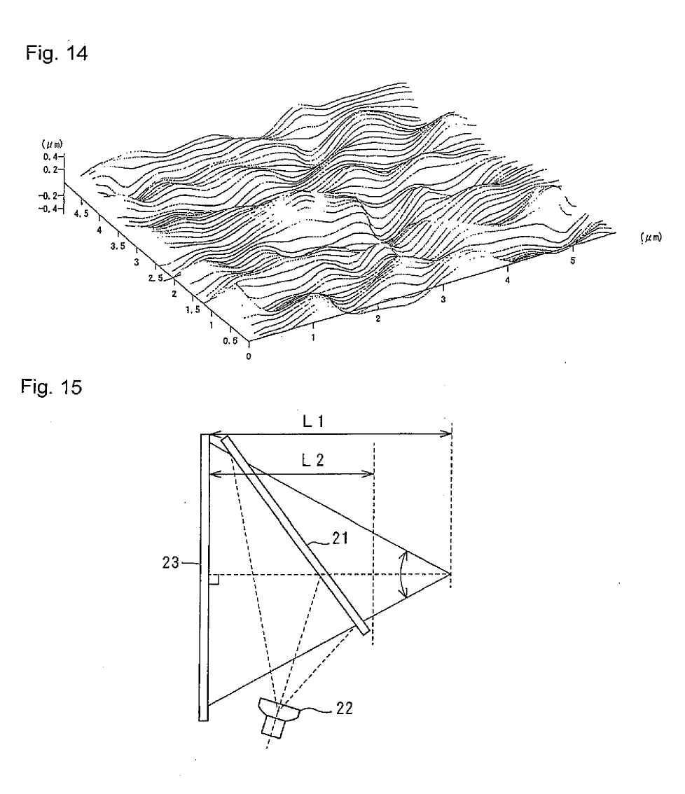

Light reflector was made similarly to Example 1, except for using glass base material. The light reflector was subjected to evaluation tests similarly to Example 1. FIG. 14 shows the three-dimensional surface profile of the reflecting film measured with an object lens having magnifying power of 100 times, from which it can be seen that the reflecting film has a rough surface with relatively large number of sharp protrusions. This result also shows that the surface height is 0.44 μm at the peak and −0.49 μm at the bottom, which means PV value of about 0.93 μm.

Reflectivity measured similarly to Example 1 was 90%.

### EXAMPLE 2

The following components were mixed in proportions shown in Table 2, and were kneaded in a kneader at the normal temperature thereby to obtain the thermosetting resin composition for the reinforcement layer and the gloss layer.

Unsaturated polyester resin: Product name U-PICA 7123 manufactured by Japan U-PiCA Company, Ltd.
Thermoplastic resin: Product name A-25 manufactured by Japan U-PiCA Company, Ltd.
Inorganic filler: Product name NS-200 from NITTO FUNKA KOGYO K.K.
Reinforcement fiber: Product name RES03-BM5 manufactured by Nippon Glass Fiber, Co., Ltd.
Curing agent (A): Product name Perhexa HC manufactured by NOF CORPORATION
Curing agent (B): Product name Perbutyl Z manufactured by NOF CORPORATION
Mold releasing agent: Product name Efco-Chem ZNS-P manufactured by ADEKA CORPORATION

TABLE 2

| | Proportion in | Proportion in |
|---|---|---|
| | reinforcement layer | gloss layer |
| Component | (% by mass) | (% by mass) |
| Unsaturated | 11.8 | 11.8 |
| polyester resin | | |
| Thermoplastic | 7.9 | 7.9 |
| resin | | |
| Inorganic filler | 63.9 | 78.9 |
| Reinforcement | 15 | 0 |
| fiber | | |
| Curing agent (A) | 0.1 | 0.1 |
| Curing agent (B) | 0.3 | 0.3 |
| Mold releasing | 1 | 1 |
| agent | | |

The thermosetting resin composition for the reinforcement layer was poured into a mold for transfer molding, and molding process was carried out by using a 50-ton transfer molding machine (manufactured by Ohji Kikai), thereby to obtain the reinforcement layer having thickness of 2 mm, under the following conditions.
Molding temperature: 165° C.
Mold clamping pressure: 150 kgf/cm²
Injection pressure: 50 kgf/cm²
Curing time: 3 minutes

Then the thermosetting resin composition for the gloss layer was poured into the same mold, thereby to obtain the gloss layer having thickness of 1 mm on the surface of the reinforcement layer, under the following conditions. In this Example, the mold having such a structure that had the gas vent for degassing was used.
Molding temperature: 165° C.
Mold clamping pressure: 150 kgf/cm²
Injection pressure: 50 kgf/cm²
Curing time: 3 minutes

The reinforced plastic layer and the glossy plastic layer thus obtained had linear expansion coefficient 2.0×10⁻⁵/° C. and 0.8×10⁻⁵/° C., respectively, with a difference 1.2×10⁻⁵/° C. Thus it can be seen that the reinforced plastic layer and the glossy plastic layer are integrated without the possibility of being separated by the difference in expansion coefficient.

The light reflector was made by forming the layers (i) through (iv) as described below in order on the plastic base material which was released from the mold, without processing the surface.
(i) Adhesion enhancing film 51: Y₂O₃ (40 nm thick)
(ii) Reflecting film 52: Silver Ag (100 nm thick)
(iii) First transparent dielectric layer 53: Magnesium fluoride MgF₂ (73 nm thick)
(iv) Second transparent dielectric layer 54: Lanthanum titanate La₂Ti₃O₈ (60 nm thick)

The layers were formed under the same conditions as in Example 1.

The light reflectors obtained in Example 2 were subjected to the following evaluation tests.

### <Strength Test>

Bending strength was measured on the gloss layer, the reinforcement layer and the base material which combined the former, according to JIS K6911 (1995), with the results shown in Table 3.

TABLE 3

| | Gloss | Reinforcement | Base |
|---|---|---|---|
| | layer | layer | material |
| Bending strength | 40 | 120 | 90 |
| (MPa) | | | |

The light reflectors obtained in Example 2 showed the surface condition, SEM observation of the surface, (111) peak intensity of X-ray diffraction and reflectivity, all the same as those of Example 1.

### COMPARATIVE EXAMPLE 2

Light reflector was made similarly to Example, except for using a base material molded by using only the material of the same composition as the gloss layer (hereafter referred to as glossy base material) and a base material molded by using only the material of the same composition as the reinforcement layer (hereafter referred to as reinforced base material). The light reflector was subjected to evaluation tests for reflectivity and PV value similarly to Example. The results are shown in Table 4.

TABLE 4

| | Glossy | Reinforced |
|---|---|---|
| Base material | base material | base material |
| Reflectivity (%) | 98 | 85 |
| PV value (μm) | 0.4 | 0.8 |

### EXAMPLE 3

Light reflector was made similarly to Example 1, except for using the mold shown in FIG. 8, FIG. 9. The plastic base material which has been molded showed surface roughness Rz of 0.4 μm in a portion corresponding to the central portion of the reflecting film. The mold having the gap C made it possible to form protrusion measuring 0.03 mm in height and 0.03 mm in width at a position corresponding to the border between the peripheral portion and the central portion of the reflecting film surface. The peripheral portion had a width of (distance between the periphery and the protrusion) was about 1 mm.

The light reflectors obtained in Example 3 were subjected to the following evaluation tests.

### <Corrosion Test (Humidity Resistance Test)>

The light reflectors obtained in Example 3 were kept in atmosphere at temperature of 60° C. and humidity of 95% for 100 hours, and progress of corrosion was observed. While the peripheral portion outside of the protrusion was corroded, no corrosion was observed in the central portion within the protrusion.

In the plane mirror made by coating the glass base material with the reflecting film, in contrast, corrosion which occurred along the periphery proceeded about 3 mm inward because there was no protrusion.

Thus it was confirmed that the protrusion prevents the corrosion occurring outside of the protrusion from proceeding into the light reflecting region located inside of the protrusion.

The light reflectors thus obtained showed the surface condition, reflectivity, (111) peak intensity of X-ray diffraction, all the same as in Example 1.

1-39. (canceled)

40. A light reflector comprising a plastic base material and a reflecting film containing silver and formed on the surface of the plastic base material, wherein the surface of said reflecting film has a PV value of 0.5 μm or less.

41. (canceled)

42. The light reflector according to claim 40, wherein thermal deformation temperature of the plastic base material is 130° C. or higher.

43. The light reflector according to claim 40, wherein the reflecting film has a smooth surface without sharp protrusions.

44. The light reflector according to claim 40, wherein reflectivity of the reflecting film surface is 96% or higher.

45. The light reflector according to claim 40, wherein the plastic base material is a molded article of thermosetting resin.

46. The light reflector according to claim 45, wherein said thermosetting resin contains a mold releasing agent.

47. The light reflector according to claim 40, wherein said plastic base material is a molded article of a thermosetting resin composition comprising 7 to 19% by mass of an unsaturated polyester resin, 6 to 19% by mass of a thermoplastic resin, 70 to 84% by mass of an inorganic filler, 5% by mass or less of reinforcing fibers and 0.1 to 3% by mass of a curing agent.

48. The light reflector according to claim 40, wherein said plastic base material comprises a reinforced plastic layer which contains 8 to 20% by mass of reinforcing fibers, and a glossy plastic layer which contains 5% by mass or less of reinforcing fibers and is formed on the reinforced plastic layer; and
said reflecting film is formed on the glossy plastic layer of the plastic base material.

49. The light reflector according to claim 48, wherein said glossy plastic layer is thinner than said reinforced plastic layer.

50. (canceled)

51. The light reflector according to claim 48, wherein difference in linear expansion coefficient between said reinforced plastic layer and the glossy plastic layer is 3×10⁻⁵/° C. or less.

52. The light reflector according to claim 48, wherein said reinforced plastic layer is made by molding a thermosetting resin composition comprising 7 to 19% by mass of an unsaturated polyester resin, 6 to 19% by mass of a thermoplastic resin, 50 to 78% by mass of an inorganic filler, 8 to 20% by mass of reinforcing fibers and 0.1 to 3% by mass of a curing agent.

53. The light reflector according to claim 48, wherein said glossy plastic layer is made by molding a thermosetting resin composition comprising 7 to 19% by mass of an unsaturated polyester resin, 6 to 19% by mass of a thermoplastic resin, 70 to 84% by mass of an inorganic filler, 5% by mass or less reinforcing fibers and 0.1 to 3% by mass of a curing agent.

54. The light reflector according to claim 40, wherein said plastic base material has a protrusion provided along the periphery so as to surround the central portion which serves as a reflecting surface to project an image in the light film.

55. The light reflector according to claim 40, wherein said reflecting film shows (111) peak intensity of X ray diffraction which is 20 times or more than the sum of other peaks.

56. The light reflector according to claim 40, wherein an adhesion enhancing film is interposed between said reflecting film and the base material.

57. The light reflector according to claim 56, wherein said adhesion enhancing film comprises at least one kind selected from Cr, CrO, Cr₂O₃, Y₂O₃, LaTiO₃, La₂Ti₃O₈, SiO₂, TiO₂ and Al₂O₃.

58. A method of manufacturing the light reflector comprising a plastic base material, an adhesion enhancing film, a reflecting film containing silver and a reflection improving film, and the adhesion enhancing film, the reflecting film containing silver and the reflection improving film being laminated in this order on the surface of the plastic base material, which comprises
holding said plastic base material in a chamber,
supplying gas for generating plasma into said chamber,
applying a high frequency electric field in the space within said chamber,
heating and evaporating evaporation materials which form the films in said chamber, and
controlling an amount of a gas to be supplied, wherein the amount of said gas supplied into said chamber is controlled to be smaller in the latter period than in the early period of forming each film on said plastic base material,
wherein the adhesion enhancing film, the reflecting film containing silver and the reflection improving film are formed by a thin film forming method which keeps the plastic base material at a temperature not higher than 60° C. during said each film forming process.

59. A projector comprising a plastic base material and a reflecting film containing silver and formed on the surface of the plastic base material, wherein the surface of said reflecting film has a PV value of 0.5 μm or less.

60. (canceled)

61. The projector according to claim 59, wherein thermal deformation temperature of the plastic base material is 130° C. or higher.

62. The projector according to claim 59, wherein said reflecting film has a smooth surface without sharp protrusions.

63. The projector according to claim 59, wherein reflectivity of the reflecting film surface is 96% or higher.

64. The projector which projects an image on a screen via at least three light reflectors, wherein
when defining said three light reflectors as first, second and third light reflectors along the light passing direction, at least the first and second light reflectors are composed by forming the reflecting films containing silver on the surface of the plastic base material, and the reflecting films have a PV value of 0.5 μm or less.

65. The light reflector according to claim 54, wherein said protrusion measures from 0.01 to 0.05 mm in height and from 0.01 to 0.05 mm in width.

66. The light reflector according to claim 54, wherein said central portion has surface roughness Rz of 0.5 μm or less.

67. The light reflector according to claim 40, wherein said reflecting film has a thickness from 100 to 200 nm.

68. The light reflector according to claim 40, wherein a reflection improving film is formed on the surface of said reflecting film.

69. The light reflector according to claim 68, wherein said reflection improving film is a transparent dielectric layer comprising two or more layers formed from a compound selected from a group consisting of Y₂O₃, MgF₂, LaTiO₃, La₂Ti₃O₈, SiO₂, TiO₂ and Al₂O₃.

70. The light reflector according to claim 68, wherein said reflection improving film is formed by forming at least a transparent dielectric layer having a high refractivity index and a transparent dielectric layer having a low refractivity index on the surface of the reflecting film.

71. The light reflector according to claim 47 or 51, wherein said inorganic filler has mean particle size in a range from 0.1 to 60 μm.

72. The light reflector according to claim 46, 52 or 53, wherein said reinforcing fiber is 1 to 3 mm in length.

73. A method of manufacturing the light reflector, which comprises
filling a mold with a thermosetting resin composition comprising 7 to 19% by mass of an unsaturated polyester resin, 6 to 19% by mass of a thermoplastic resin, 70 to 84% by mass of an inorganic filler, 5% or less by mass of reinforcing fibers and 0.1 to 3% by mass of a curing agent, and heating at a temperature from 135 to 180° C. so as to cure the thermosetting resin composition to form a plastic base material; and
forming a reflecting film containing silver on the surface of the plastic base material.

74. A method for manufacturing the light reflector, which comprises laminating a reinforced plastic layer including 8 to 20% by mass of reinforcing fibers and a glossy plastic layer containing 5% by mass or less of reinforcing fibers so as to obtain the plastic base material; and
forming a reflecting film containing silver on the surface of the glossy plastic layer of the plastic base material.

75. The method for manufacturing the light reflector according to claim 74, wherein a mold is filled with the thermosetting resin composition prepared for either the reinforced layer or the gloss layer so as to mold either the reinforced plastic layer or the glossy plastic layer, followed by pouring of the other thermosetting resin composition and molding the glossy plastic layer or the reinforced plastic layer.

76. The method for manufacturing the light reflector according to claim 75, wherein, after molding one thermosetting resin composition, the other thermosetting resin composition is molded after degassing the inside of said mold or while degassing.

77. A method of manufacturing a light reflector which comprises molding a thermosetting resin composition to obtain a plastic base material, and coating the surface of the plastic base material with the reflecting film,
wherein said plastic base material is molded by using a mold that has a recess between a portion corresponding to the peripheral portion of the plastic base material and a portion corresponding to the central portion, so as to form a protrusion in the peripheral portion of the plastic base material to surround the central portion of the reflecting film surface.

78. The method for manufacturing a light reflector according to claim 77, wherein said mold comprises a mold member corresponding to the peripheral portion of said plastic base material and a mold member corresponding to the central portion, while there is a gap between both mold members when both mold members are integrated together.

79. The method for manufacturing a light reflector according to claim 73, 74 or 77, wherein an adhesion enhancing film is formed on the surface of said plastic base material prior to the formation of the reflecting film containing silver on the surface of said plastic base material.

80. The method for manufacturing a light reflector according to claim 73, 74 or 77, wherein after forming the reflecting film containing silver on the surface of said plastic base material, a reflection improving film is formed on the surface of the reflecting film.

81. The method for manufacturing a light reflector according to claim 80, wherein said reflection improving film comprises two or more transparent dielectric layers.

82. The light reflector according to claim 81, wherein said reflection improving film is formed by laminating at least a transparent dielectric layer having a high refractivity index and a transparent dielectric layer having a low refractivity index on the surface of the reflecting film.
